(19) United States
(12) Patent Application Publication
(10) Pub. No.: US 2008/0230570 A1
(43) Pub. Date: Sep. 25, 2008

(54) Liquid Dispensers

(76) Inventors: Matthew Eric Smith, Isle of Man (GB); Karl Mondszein, Nottinghamshire (GB)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 12/063,913

(22) PCT Filed: Aug. 16, 2006
(86) PCT No.: PCT/GB2006/003066

§ 371 Date: Feb. 15, 2008

(30) Foreign Application Priority Data
Aug. 18, 2005 (GB) 0516963.6

(51) Int. Cl. B67D 3/00

(52) U.S. Cl. 222/518

(57) ABSTRACT

A liquid dispenser, such as a tap for a liquid container particularly a wine box, includes an outer tube (2) with a discharge opening (14) formed in its side wall and an inner tube (4), which is at least partially accommodated within the outer tube (2) and defines with it an annular space, which accommodates an annular sealing member (20), which forms a seal with the outer tube. One end of the inner tube (4) is closed and one end of the outer tube (2) is integrally connected to the inner tube (4) by a flexible, integral annular web (10), whose width in the radial direction is greater than that of the annular space. The other end of the outer tube (2) is adapted for connection to the liquid container. The inner tube (4) is movable longitudinally within the outer tube (2) between an open position, in which there is a liquid flow path between the said outer end of the outer tube and the discharge opening (14), and a closed position, in which the outer surface of the inner tube (4) forms a sliding seal with sealing member (20) and the said liquid flow path is sealed.

The present invention relates to liquid dispensers of resealable type, that is to say devices that may be selectively opened to dispense a liquid from a container and may then be closed again and will then form a reliable seal and prevent further dispensing of liquid until it is desired. The invention is particularly applicable to so-called wine taps, that is to say taps or dispensers which are adapted to be connected to the liquid container of a so-called wine box for selectively dispensing wine within the container, but is applicable also to dispensers for use with a wide range of other sorts of container, e.g. beverage cartons, cooking oil containers and the like.

Conventional wine taps include a valve member which is connected or forms part of an actuator and is located in a flow passage which is divergent in the direction of flow and communicates with the interior of the wine container, typically a flexible bag. In the closed position, the valve member forms a seal with the wall of the flow passage. If it is desired to dispense some wine, the actuator is actuated and the valve member moved in the flow direction against the restoring force of a spring whereby liquid can flow through the gap which is created between the valve member and the wall of the flow passage and thus out to the exterior. The spring may take many forms but is typically an elastomeric cover which is connected to a fixed portion of the wine tap and to the end of a composite valve member/actuator.

Whilst effective, such known wine taps are complex in that they comprise at least three components which must be manufactured separately and then assembled. It is, therefore, the object of the invention to provide a resealable liquid dispenser which is cheaper and simpler than known dispensers and, in particular, has a reduced part count and preferably consists of only a single component.

According to the present invention, a liquid dispenser includes an outer tube with a discharge opening formed in its side wall and an inner tube, which is at least partially accommodated within the outer tube and defines with it an annular space, which accommodates an annular sealing member which forms a seal with the outer tube, one end of the inner tube being closed and one end of the outer tube being integrally connected to the inner tube by a flexible, integral annular web, whose width in the radial direction is greater than that of the annular space, the other end of the outer tube being adapted for connection to a liquid container, the inner tube being movable longitudinally within the outer tube between an open position, in which there is a liquid flow path between the said other end of the outer tube and the discharge opening, and a closed position, in which the outer surface of the inner tube forms a sliding seal with the sealing member and the said liquid flow path is sealed.

Thus the dispenser in accordance with the invention comprises an outer tube, which has an opening in its side wall and at least partially accommodates an inner tube which is connected to it by a flexible integral web whose width in the radial direction is greater than that of the annular space. Provided within the outer tube and forming a seal with it is an annular sealing member. The inner tube may be moved longitudinally within the outer tube by virtue of the flexibility of the integral annular web, which closes the annular space between the inner and outer tubes, between an open position in which there is a liquid flow path between the end of the outer tube which, in use, is connected to a liquid container and communicates with an opening in that container, and the discharge opening, and a closed position, in which the outer surface of the inner tube forms a sliding seal with the sealing member and the liquid flow path is closed.

The construction of the inner and outer tubes and the resilient annular web connecting them inherently lends itself to manufacture in the form of a one-piece plastic injection moulding. The sealing member may be a separate component which is inserted into the outer tube after manufacture thereof but this does of course mean that the dispenser would then include two components. It is therefore preferred that the entire dispenser constitutes a one-piece plastic moulding. It is of course not possible to mould the sealing member and the remainder of the dispenser in one piece with the sealing member being moulded in its operative position and it is therefore preferred that the sealing member is integrally connected to the outer tube and connected thereto by an integral tab. The sealing member can be moulded laterally adjacent the remainder of the dispenser and connected to it by the tab and can then be moved into its operative position whilst bending the tab. It is preferred that the sealing member is connected to the outer surface of the outer tube by means of the integral tab and that the end surface of the said other end of the outer tube has a recess formed in it in which the integral tab is received. This will result in the outer tube presenting a flat end surface with no protuberances, which will facilitate its connection to a liquid container, e.g. a wine bag, for instance by welding.

The dispenser or tap will be opened by moving the inner tube relative to the outer tube and in order to facilitate the user grasping the inner tube it is preferred that the said one end of the inner tube carries a radially projecting flange which engages the said one end of the outer tube, when the inner tube is in the closed position.

It is preferred that the annular web is resilient and exerts a biasing force on the inner tube urging it towards the open position or the closed position. The fact that the radial dimension of the annular web is greater than the corresponding dimension of the annular space means that the inner tube is inherently bistably accommodated within the outer tube. It will therefore have two rest positions within the outer tube and when it is situated at positions intermediate these two rest positions the resilience of the annular web will urge it towards the closer of those two positions. The tubes and the annular web are preferably so constructed that when the flange is in engagement with the said one end of the outer tube it has not reached an equilibrium position and this will mean that the resilience of the web will create a contact pressure between the flange and the said one end of the outer tube.

In one embodiment, the inner tube is so constructed that it is not in contact with the sealing member, when it is in the open position, whereby the said liquid flow path will pass around the other end of the inner tube. In an alternative embodiment, the inner tube is so constructed that it is in sealing contact with the sealing member in both the open and the closed positions and this necessitates the provision of a flow opening in the inner tube, whereby, when the inner tube is in the open position, the liquid flow path will pass from the said other end of the outer tube, which in use will communicate with the interior of the liquid container, into the inner tube and then through the flow opening in the inner tube to the discharge opening in the outer tube.

The annular sealing member, which forms a sliding seal with the inner tube, may take various forms but it is preferred that it is of U-shaped cross-section and that the width of the cross-section increases towards the free ends of the limbs of the U-shaped cross-section. The sealing member and the inner tube can then be so constructed that the inner tube deforms the inner limb of the U-shaped cross-section in the outward direction and the contact pressure which this will produce will enhance the integrity of the sliding seal. If an increased pressure were to act within the U-shaped cross-section, it would tend to force the two limbs of the cross-section outwardly and thus further enhance the sealing integrity. Depend upon the conditions of use and the liquid which is to be dispensed, it is sometimes to be expected that the pressure within the liquid container will be superatmospheric or subatmospheric. In order to maximise the sealing action of the sealing member, the U-shaped sealing member may be positioned so that its interior communicates with that region which is expected to be subjected, at least at certain times, to a superatmospheric pressure. In practice, it more usually occurs that there is a superatmospheric pressure within the liquid container, e.g. due to an increase in ambient temperature, and it is therefore preferred that the open side of the U-shaped cross-section is directed towards the said other end of the outer tube and is thus, in use, exposed to any superatmospheric pressure that may prevail in the liquid container.

Further features and details of the invention will be apparent from the following description of one specific embodiment which is given by way of example only with reference to the accompanying diagrammatic cross-sectional drawings, in which:

FIG. 1 is a view of a first embodiment of a wine tap in accordance with the invention in the closed or sealed position;

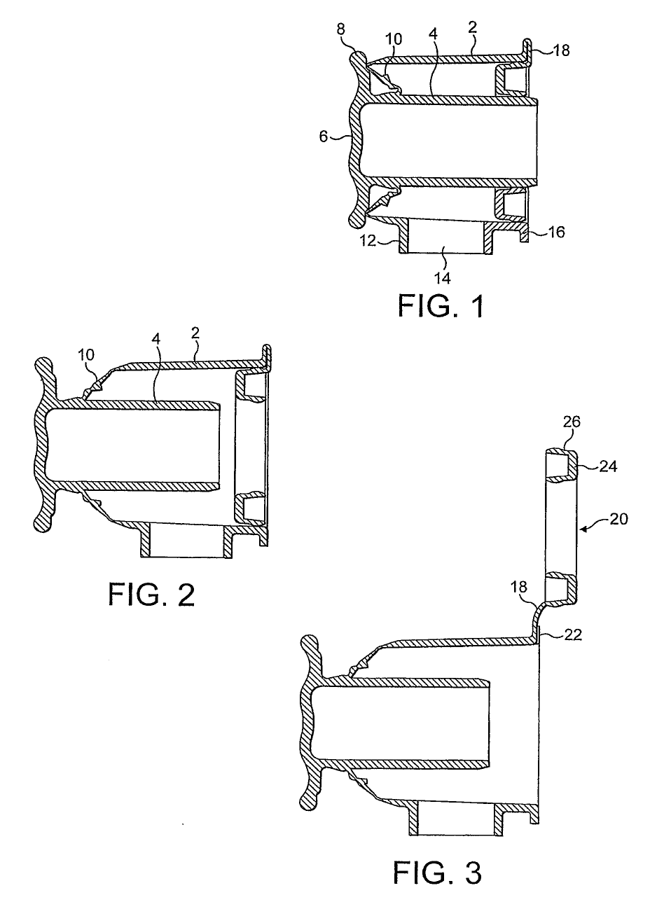

FIG. 2 is a similar view of the wine tap of FIG. 1 in the open position;

FIG. 3 is a similar view of the wine tap of FIGS. 1 and 2 in the as moulded configuration, that is to say before the sealing member has been pivoted into its operative position within the outer tube; and

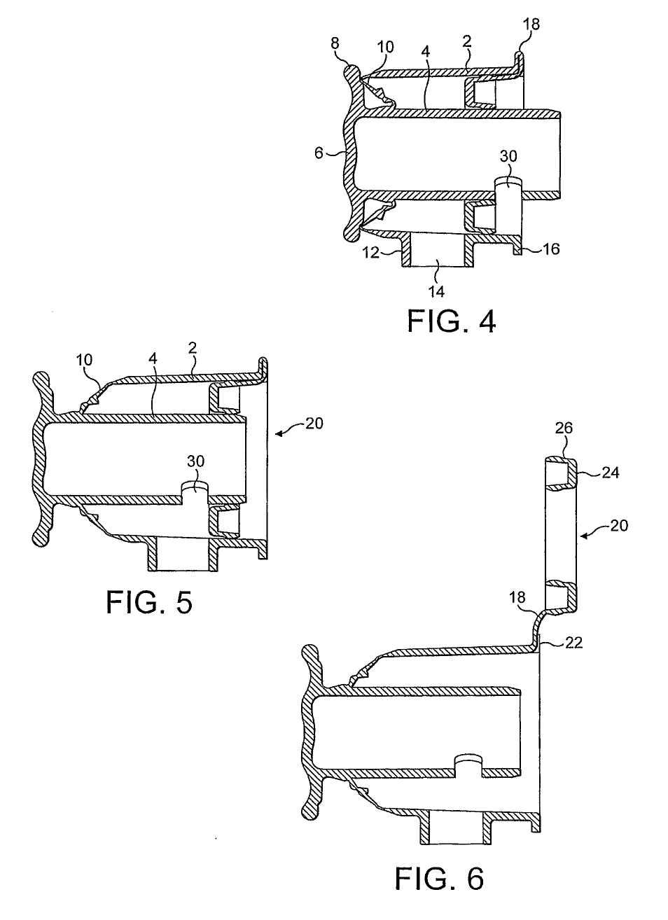

FIGS. 4, 5 and 6 are views corresponding to FIGS. 1, 2 and 3, respectively, of a second embodiment.

The wine tap illustrated in FIGS. 1 and 2 includes an outer tube 2, partially accommodated within which is an inner tube 4. One end of the inner tube 4 is closed by a lid 6 which is extended outwardly in the radial direction to constitute a peripheral flange 8. The inner tube 4 is connected at a position on its side wall relatively close to the lid 6 by means of an integral web 10 to the adjacent end of the outer tube 2. This annular web 10 has a dimension in the radial direction which is greater than that of the annular gap defined between the tubes 2 and 4. The web 10 itself and its connections to the tubes 2 and 4 are resilient. At one circumferential position of the outer tube 2, which will be the lowermost position in use, the outer tube 2 is formed with a short depending pipe or spigot 12 which defines a flow opening 14. At its end opposite to the integral web 10, the outer tube 2 is provided with a radially outwardly extending flange 16. Integrally connected to this flange 16 at one circumferential position by means of an integral tab or hinge 18 is an annular sealing member 20. In the use configuration shown in FIGS. 1 and 2, the sealing member 20 is accommodated within the associated end of the outer tube 2 and the integral tab 18 is bent over to extend across the surface of the flange 16. In order to ensure that the tab 18 does not project beyond the plane of the end surface of the flange 16, that flange is provided with a small recess 22, whose shape matches that of the tab 18, whereby the tab 18 is accommodated flush within the recess 22 and the end surface of the flange 16 is substantially planar over its entire surface.

As may be seen, the annular sealing member 20 is of open U-shaped channel section with a base 24 and side limbs 26. The width of the channel section increases progressively in the direction away from the base 24. The sealing member 20 is so dimensioned that, when in the use position shown in FIGS. 1 and 2, the outer limb 26 has to be deformed inwardly somewhat to accommodate it within the outer tube 2 and the resilience of the material means that the outer limb 26 and the tube 22 engage with a contact pressure which ensures the integrity of the seal between them.

Due to the fact that the length of the annular web 10 in the radial direction is greater than the radial dimension of the annular gap defined between the tubes 2 and 4, the inner tube 4 is movable longitudinally with respect to the outer tube 2 between two rest positions in which the web 10 is not deformed. At intermediate positions between these two rest positions, the web 10 is inherently deformed and thus exerts a force on the inner tube 2 tending to move it towards one or other of the rest positions.

FIG. 2 illustrates one of these rest positions and when in this position the inner tube 4 is not in contact with the sealing member 20. There is therefore a liquid pathway between the flow opening defined by the flange 16, which in use will communicate with the interior of a liquid container, and the flow opening 14. Liquid can therefore flow freely out of the container through the discharge opening 14. FIG. 1 illustrates the other rest position and in this position the outer surface of the inner tube 4 is in sliding contact with the inner limb of the U-shaped cross-section of the sealing member 20. The sealing member 20 and the inner tube 4 are so dimensioned that this contact necessitates a slight outward deformation of the inner limb 26 and the contact between that limb and the inner tube 4 is therefore under a constant pressure and this ensures the integrity of the liquid seal between the sealing member 20 and the tube 4. In the closed position shown in FIG. 1, the liquid pathway between the opening defined by the flange 16 and the discharge opening 14 is sealed by the sealing member and no liquid may flow out of the container. The first rest position is an equilibrium position in which the web 10 is not deformed and thus exerts no force on the tubes. However, in practice, the inner tube 4 may not in fact be in its second equilibrium position in the configuration shown in FIG. 1. Thus the annular web 10 may be so dimensioned that the equilibrium position of the tube 4 would in fact be somewhat to the right of that shown in FIG. 1. This means that the web 10 is still deformed in the position shown in FIG. 1 and is thus still exerting a biasing force on the tube 4 acting to the right, as seen in the figure. This means that the flange 10 engages the left-hand end of the outer tube 2 under a contact pressure. This bistable arrangement of the inner tube 4 within the outer tube 2 is highly advantageous because as the inner tube 4 is moved to the left, as seen in FIG. 1, the force exerted by the web 10 on the tube 4 will attempt to return it to the closed position. However, once the tube 4 has moved beyond the “top dead centre” position, in which the web 10 extends approximately radially, the force exerted by the web 10 on the tube 4 will tend to move it to the left, that is to say into the open position. The tap in accordance with the invention will therefore invariably be in the fully open position or the wholly closed position and it is not possible for the tap to be left in a position in which liquid is allowed to drain at a low rate, albeit inadvertently, from the container.

The wine tap illustrated in FIGS. 1 to 3 is a one-piece moulding of a resilient plastic material, such as polypropylene. Injection moulding technology does of course not permit the sealing member 20 to be moulded in the position shown in FIGS. 1 and 2 and it is therefore moulded in the position shown in FIG. 3, in which it is situated laterally of the outer tube 2 and connected to the outer edge of the flange 16 by the tab 18. At any time after the moulding operation is complete, the sealing member 20 may be moved into the operative position shown in FIGS. 1 and 2 by simply rotating it through 180° about the integral hinge 18. It is then pushed into the adjacent end of the open tube 2 and its limbs 26 are dimensioned so that, as explained above, insertion of it into the outer tube 2 will necessitate a slight inward deformation of the outer limb 26, thereby creating the desirable sealing contact pressure between the outer limb 26 and the inner surface of the tube 2.

The modified embodiment shown in FIGS. 4 to 6 is very similar indeed to that shown in FIGS. 1 to 3 and only the differences between the two embodiments will be described. Similar components in the second embodiment are designated by the same reference numerals as in FIGS. 1 to 3. In this second embodiment, the inner tube 4 is longer than in the first embodiment and this means that when it is moved from the closed position shown in FIG. 4, in which it is in sliding contact with the sealing member, into the open position shown in FIG. 5, it is still in sealing contact with the sealing member 20. In order to provide the necessary liquid flow path in the open position, the inner tube 4 is provided with a flow opening 30 in its side wall, which is situated to the right of the sealing member 20 in the closed position, shown in FIG. 4, but to the left of the sealing member 20, when in the open position, as shown in FIG. 5. Thus when the inner tube 4 is in the open position, a liquid flow path is created between the opening defined by the flange 16, into the interior of the inner tube 4 and then out through the flow opening 30 to the discharge opening 14. In all other respects, the second embodiment is the same as that of the first embodiment.

1. A liquid dispenser including an outer tube (2) with a discharge opening (14) formed in its side wall and an inner tube (4), which is at least partially accommodated within the outer tube (2) and defines with it an annular space, which accommodates an annular sealing member (20) which forms a seal with the outer tube, one end of the inner tube (4) being closed (6) and one end of the outer tube (2) being integrally connected to the inner tube (4) by a flexible, integral annular web (10), whose width in the radial direction is greater than that of the annular space, the other end of the outer tube (2) being adapted for connection to a liquid container, the inner tube (4) being movable longitudinally within the outer tube (2) between an open position, in which there is a liquid flow path between the said outer end of the outer tube and the discharge opening (14), and a closed position, in which the outer surface of the inner tube (4) forms a sliding seal with the sealing member (20) and the said liquid flow path is sealed.

2. A dispenser as claimed in claim 1 which constitutes a one-piece plastic moulding.

3. A dispenser as claimed in Clam 2 in which the sealing member (20) is integrally connected to the outer tube (2) by means of an integral tab (18).

4. A dispenser as claimed in claim 3 in which the sealing member (20) is connected to the outer surface of the outer tube (2) by the integral tab (18) and that the end surface of the said other end of the outer tube (2) has a recess (22) formed in it in which the integral tab (18) is received.

5. A dispenser as claimed in claim 1 in which the said one end of the inner tube (4) carries a radially projecting flange (8) which engages the said one end of the outer tube (2), when the inner tube (4) is in the closed position.

6. A dispenser as claimed in claim 5 in which the annular web (10) is resilient and exerts a biasing force on the inner tube (4) urging it towards the open position or the closed position, whereby the inner tube (2) is bistable and, when the flange (8) is in engagement with the said one end of the outer tube (2), the resilience of the web (10) creates a contact pressure between them.

7. A dispenser as claimed in claim 1 in which the inner tube (4) is not in contact with the sealing member (20), when it is in the open position, whereby the said liquid flow path passes around the other end of the inner tube (4).

8. A dispenser as claimed in claim 1 in which the inner tube (4) is in sealing contact with the sealing member (20) in both the open and closed positions and a flow opening (30) is formed in the inner tube (4), whereby, when the inner tube (4) is in the open position, the liquid flow path extends into the inner tube (4) and through the flow opening (30).

9. A dispenser as claimed in claim 1 in which the annular sealing member (20) is of U-shaped cross-section and the width of the cross-section increases towards the free ends of the limbs (26) of the U-shaped cross-section.

10. A dispenser as claimed in claim 9 in which the open side of the U-shaped cross-section is directed toward the said other end of the outer tube (2).

11. A dispenser as claimed in claim 2 in which the said one end of the inner tube (4) carries a radially projecting flange (8) which engages the said one end of the outer tube (2), when the inner tube (4) is in the closed position.

12. A dispenser as claimed in claim 11 in which the annular web (10) is resilient and exerts a biasing force on the inner tube (4) urging it towards the open position or the closed position, whereby the inner tube (2) is bistable and, when the flange (8) is in engagement with the said one end of the outer tube (2), the resilience of the web (10) creates a contact pressure between them.

13. A dispenser as claimed in claim 3 in which the said one end of the inner tube (4) carries a radially projecting flange (8) which engages the said one end of the outer tube (2), when the inner tube (4) is in the closed position.

14. A dispenser as claimed in claim 13 in which the annular web (10) is resilient and exerts a biasing force on the inner tube (4) urging it towards the open position or the closed position, whereby the inner tube (2) is bistable and, when the flange (8) is in engagement with the said one end of the outer tube (2), the resilience of the web (10) creates a contact pressure between them.

15. A dispenser as claimed in claim 4 in which the said one end of the inner tube (4) carries a radially projecting flange (8) which engages the said one end of the outer tube (2), when the inner tube (4) is in the closed position.

16. A dispenser as claimed in claim 15 in which the annular web (10) is resilient and exerts a biasing force on the inner tube (4) urging it towards the open position or the closed position, whereby the inner tube (2) is bistable and, when the flange (8) is in engagement with the said one end of the outer tube (2), the resilience of the web (10) creates a contact pressure between them.

17. A dispenser as claimed in claim 2 in which the inner tube (4) is not in contact with the sealing member (20), when it is in the open position, whereby the said liquid flow path passes around the other end of the inner tube (4).

18. A dispenser as claimed in claim 3 in which the inner tube (4) is in sealing contact with the sealing member (20) in both the open and closed positions and a flow opening (30) is formed in the inner tube (4), whereby, when the inner tube (4) is in the open position, the liquid flow path extends into the inner tube (4) and through the flow opening (30).

19. A dispenser as claimed in claim 2 in which the inner tube (4) is in sealing contact with the sealing member (20) in both the open and closed positions and a flow opening (30) is formed in the inner tube (4), whereby, when the inner tube (4) is in the open position, the liquid flow path extends into the inner tube (4) and through the flow opening (30).

20. A dispenser as claimed in claim 2 in which the annular sealing member (20) is of U-shaped cross-section and the width of the cross-section increases towards the free ends of the limbs (26) of the U-shaped cross-section.
